(19) United States
(12) Patent Application Publication
(10) Pub. No.: US 2025/0170935 A1
(43) Pub. Date: May 29, 2025

(54) SEAT ASSEMBLY AND METHOD OF ASSEMBLY

(71) Applicant: Lear Corporation, Southfield, MI (US)

(72) Inventors: Curtis Hudson, Macomb, MI (US); Haifeng Liu, Novi, MI (US); Christopher D. Johnson, Novi, MI (US); Joshua Hallock, Warren, MI (US)

(73) Assignee: Lear Corporation, Southfield, MI (US)

(21) Appl. No.: 18/952,450

(22) Filed: Nov. 19, 2024

Related U.S. Application Data
(60) Provisional application No. 63/603,686, filed on Nov. 29, 2023.

(51) Int. Cl. B60N 2/58; B60N 2/64

(52) U.S. Cl. CPC B60N 2/5833; B60N 2/5891; B60N 2/64

(57) ABSTRACT

A seat assembly and a method of manufacture. The seat assembly comprises a cushion, an attachment pad, and a trim cover. The cushion comprises a filament mesh structure that comprises a set of filaments. The attachment pad is coupled to the filament mesh structure. The trim cover is attached to the attachment pad.

### CROSS-REFERENCE TO RELATED APPLICATIONS

This application claims the benefit of U.S. provisional application Ser. No. 63/603,686, filed Nov. 29, 2023, the disclosure of which is hereby incorporated in its entirety by reference herein.

### TECHNICAL FIELD

This relates to a seat assembly and a method of assembly.

### BRIEF DESCRIPTION OF THE DRAWINGS

FIG. 1 is a perspective view of an example of a seat assembly.

FIG. 2 is schematic view of an example of a manufacturing system for making the filament mesh structure.

FIG. 3 is an exploded view of examples of a trim cover, an attachment pad, and a cushion, the cushion comprising a filament mesh structure.

FIG. 4 is a plan view of the attachment pad of FIG. 3.

FIG. 5 is a perspective view shown the attachment pad secured to the cushion.

FIGS. 6-9 are fragmentary section views that illustrate steps associated with a method of assembly.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact. without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

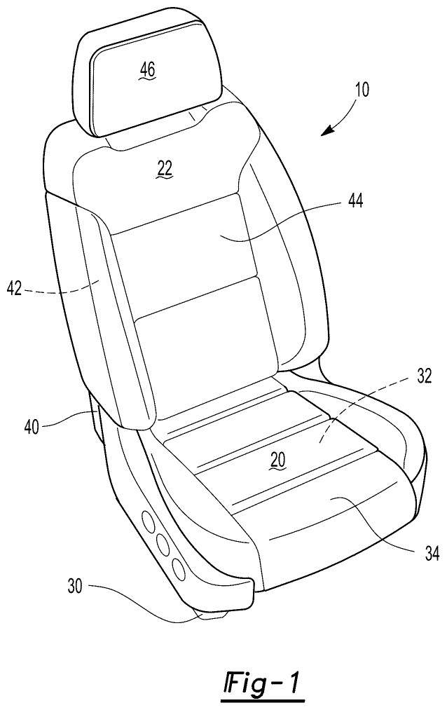

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats as shown, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad as will be discussed in more detail below.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

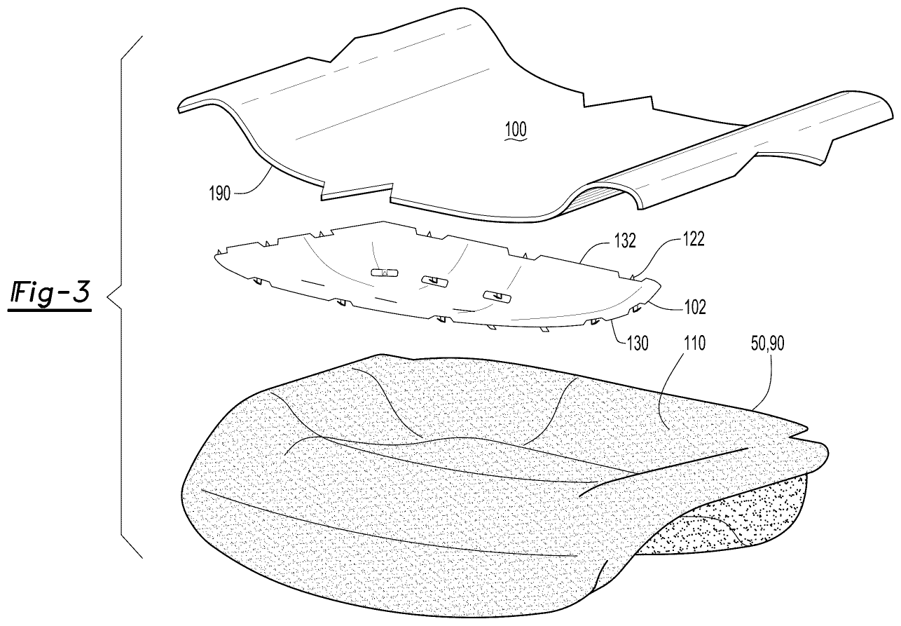

Referring to FIG. 3, an example of a cushion 50 is shown. The cushion in generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a filament mesh structure but may also be referred to as a mesh cushion, mesh structure, or stranded mesh. In FIG. 3, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

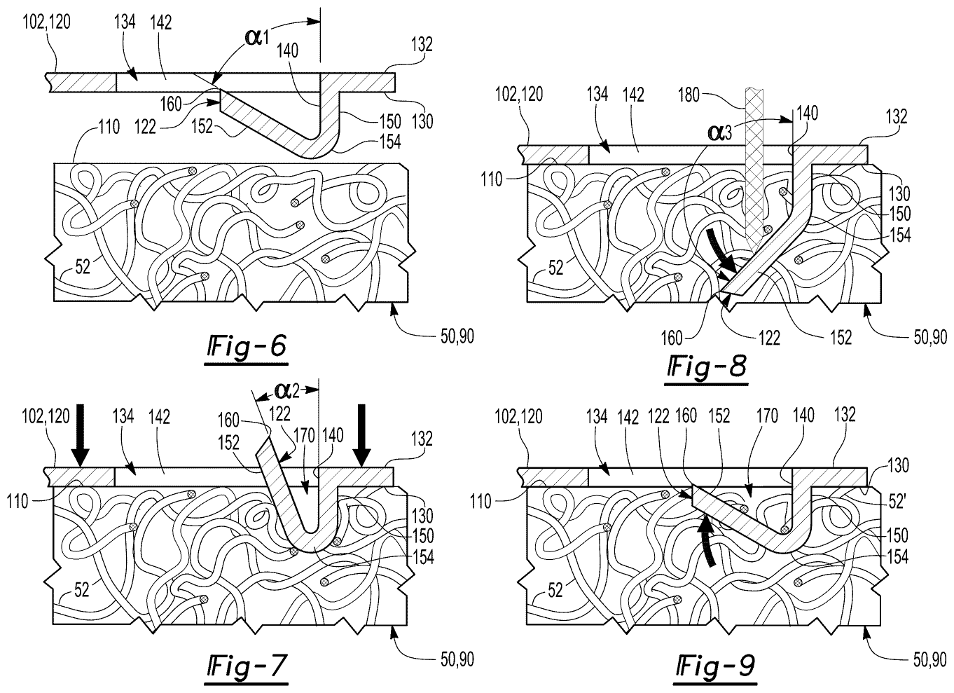

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. An example of filaments 52 is shown in FIGS. 6-9. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

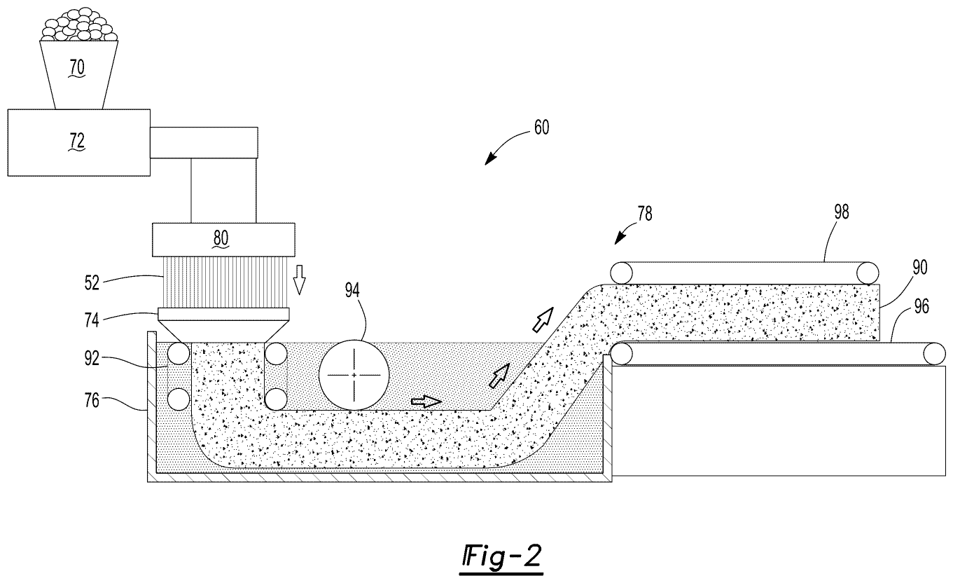

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

Referring to FIG. 3, an exploded view of a portion of the seat assembly 10 is shown that includes an example of the cushion 50, an example of a trim cover 100, and an example of an attachment pad 102.

The cushion 50 comprises the filament mesh structure 90. In FIG. 3, the cushion 50 is illustrated without depicting individual filaments 52 of the filament mesh structure 90 for clarity. In some configurations, the cushion 50 has a contoured exterior side 110. The contoured exterior side 110 may have a partially or completely nonplanar profile and may include one or more curved surfaces or curved regions. In some configurations, the contoured exterior side 110 is concave or partially concave. The contoured exterior side 110 faces toward the trim cover 100 and the attachment pad 102. Moreover, the contoured exterior side 110 may face toward a seat occupant. The contoured exterior side 110 may contact a portion of the trim cover 100 in one or more regions where the attachment pad 102 is not sandwiched between the trim cover 100 and the cushion 50 and does not separate the trim cover 100 from the cushion 50.

The trim cover 100 is generically designated with reference number 100 for convenience in reference. It is to be understood that the trim cover 100 may be the trim cover 34 of the seat bottom 20 or the trim cover 44 of the seat back 22 as previously described. A portion of the trim cover 100 is shown in FIG. 3 to make other features in this figure more visible. The trim cover 100 may be attached to the attachment pad 102 and may generally follow the curvature or contour of the attachment pad 102 or a side of the attachment pad 102 that faces away from the cushion 50.

The attachment pad 102 is disposed between the cushion 50 and the trim cover 100. In some configurations, the attachment pad 102 extends from the cushion 50 to the trim cover 100. For instance, the attachment pad 102 may extend from the contoured exterior side 110 to a side of the trim cover 100 that faces toward the contoured exterior side 110. It is also contemplated that other components, such as a heating pad, may be disposed between the trim cover 100 and the attachment pad 102.

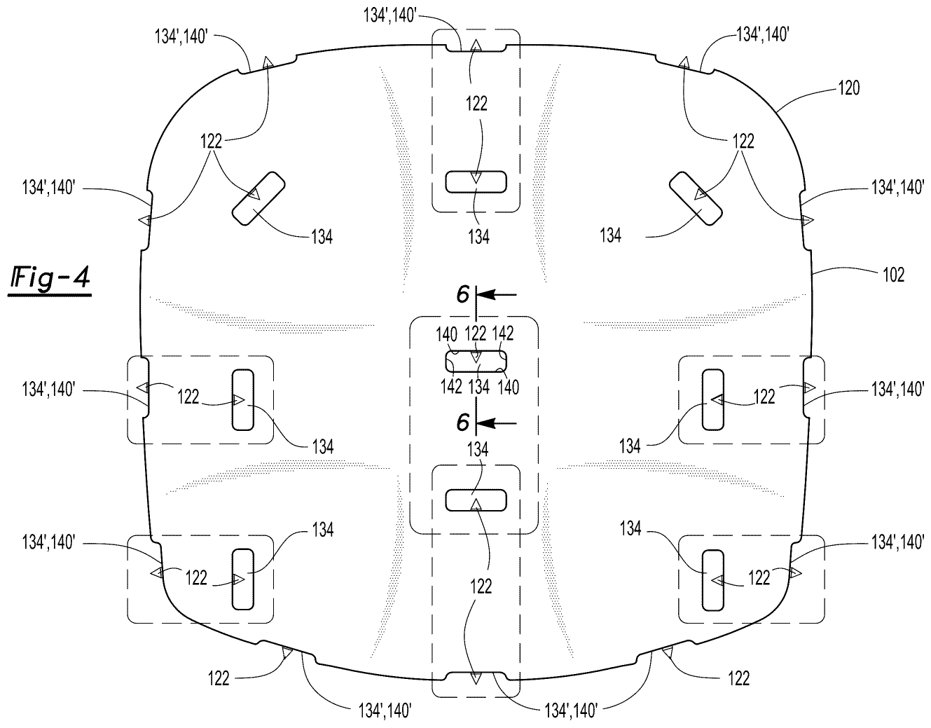

Referring to FIG. 4, a plan view of the example of the attachment pad 102 shown. The attachment pad 102 includes a body 120 and a set of hooks 122.

The body 120 is configured to support a seat occupant and facilitate mounting of the trim cover 100 to the cushion 50. The body 120 may be a panel, layer, or assembled layers having a solid or hollow construction. The body 120 may be made of multiple pieces or be configured as a unitary one-piece component that may be made of any suitable material or materials. For instance, the body 120 may be made of a polymeric material, such as thermoplastic material, such as a thermoplastic resin that is polyamide-based, polyester-based, polyimide-based, polyolefin-based, (e.g., polypropylene-based, polyethylene-based, etc.), polystyrene-based, or combinations thereof. In some configurations, the body 120 is made of the same material as the filaments 52. In other configurations, the body 120 is made of a different material than the filaments 52, but that is similar enough to the material of the cushion 50 to allow the cushion 50 and the attachment pad 102 to be recycled together without disassembly. For instance, the trim cover 100 may be detached from the attachment pad 102 and the cushion 50 and the body 120 may be ground or chopped up together for recycling without detaching the attachment pad 102 from the cushion 50.

Referring to FIGS. 3 and 4, in some configurations, the body 120 is disposed on a contoured exterior side 110 of the cushion 50. For instance, the body 120 may engage or contact the filaments 52 of the filament mesh structure 90 of the cushion 50 along the contoured exterior side 110 and may not be disposed inside of the filament mesh structure 90. The body 120 may extend along the side of the filaments 52 that make up the profile and contoured exterior side 110 of the cushion 50 and may extend from filament 52 to filament 52, thereby bridging the gaps between adjacent filaments 52 and following the exterior profile of the cushion 50 without extending into the filament mesh structure 90. In some configurations, the body 120 may not be disposed inside of a trench, hole, or groove, that extends from the contoured exterior side 110 into the filament mesh structure 90, such as a trench, hole, or groove that is cut into the filament mesh structure 90 or that is formed as a localized indentation in the filament mesh structure 90 that extends from the contoured exterior side 110. In some configurations, the body 120 includes a first side 130, a second side 132, and a plurality of apertures 134 and/or 134′.

Referring primarily to FIG. 3, the first side 130 faces toward the cushion 50. For instance, the first side 130 may face toward the contoured exterior side 110 of the cushion 50. As such, the first side 130 faces away from the trim cover 100 and may engage or contact the contoured exterior side 110. The first side 130 may follow the contour of the contoured exterior side 110. As such, the first side 130 may be disposed substantially parallel to the contoured exterior side 110. The term “substantially parallel” as used herein means the same as or very close to parallel and includes features or axes that are within ±3° of being parallel each other. In some configurations, the first side 130 or a portion thereof may be nonplanar.

The second side 132 is disposed opposite the first side 130. In some configurations, the second side 132 engages or contacts the trim cover 100. The second side 132 may also follow the contour of the contoured exterior side 110 of the cushion 50. For instance, the second side 132 may be disposed substantially parallel to the contoured exterior side 110, the first side 130, or both.

Referring primarily to FIG. 4, a plurality of apertures 134, 134′ are defined by the body 120. An aperture 134, 134′ extends from the first side 130 to the second side 132 and may be referred to as an opening, hole, or window. In some configurations, an aperture 134 may be configured as a through hole that is encircled by the body 120. In FIG. 4, nine apertures 134 are illustrated having such a configuration; however it is contemplated that a greater or lesser number of apertures 134 may be provided. These apertures 134 are spaced apart from the perimeter of the body 120. In some configurations, an aperture 134′ may be disposed along the perimeter of the body 120. In such a configuration, the aperture 134′ may extend from the first side 130 to the second side 132 but may not be encircled by the body 120 since the aperture 134′ is disposed along the perimeter. In FIG. 4, twelve apertures 134′ are illustrated along the perimeter of the body 120; however it is contemplated that a greater or lesser number of apertures 134′ may be provided. In some configurations, the body 120 is solid with the exception of the apertures 134, 134′.

The apertures 134, 134′ may have any suitable configuration. In the configuration shown in FIG. 4, the apertures 134 that are configured as through holes are depicted with a generally rectangular configuration in which a first pair of sides or pair of first sides 140 that are disposed opposite each other have a greater length than a second pair of sides or pair of second sides 142 that are disposed opposite each other and interconnect the pair of first sides 140. It is also contemplated that the apertures 134 may have a non-rectangular configuration, including but not limited to circular, elliptical, oval, triangular, or various other polygonal shapes. The apertures 134′ that are disposed along the perimeter may have fewer sides. For instance, such an aperture 134′ may have a single first side 140′ having a greater length than a second pair of sides 142′ that extend from opposite ends of the first side 140′ to the outer perimeter. Such an aperture 134′ may be an indentation along the perimeter that extends toward the center of the body 120. It is also contemplated that the second pair of sides 142′ may be omitted and the single first side 140′ may extend along an arc.

The set of hooks 122, which may also be referred to as a barb, catch, clasp, or clip, facilitates attachment of the attachment pad 102 to the cushion 50. For instance, members of the set of hooks 122 are configured to extend into the filament mesh structure 90 and catch hold of, hook on to, grasp, or couple to at least one filament 52 of the filament mesh structure 90 as will be discussed in more detail below. The set of hooks 122 extend from the body 120. For instance, the hooks 122 may be integrally formed with the body 120 as a unitary one-piece component. In some configurations, each member of the set of hooks 122 may extend from the body 120 at a different location. As such, members of the set of hooks 122 may be spaced apart from each other and may not contact or extend from each other.

Referring primarily to FIG. 6, a hook 122 may be disposed adjacent to an associated aperture 134 or 134′. For instance, a hook 122 may extend from the first side 140 or 140′ in a direction that extends toward an associated aperture 134, 134′. In some configurations, one hook 122 is associated with and disposed adjacent to each aperture 134, 134′.

In some configurations, some or all members of the set of hooks 122 may face in opposite directions with respect to each other. Examples of pairs of hooks 122 that extend in opposite directions are denoted with the dashed boxes in FIG. 4. For instance, the free end 160 of one hook 122 may face away from or point away from the free end 160 of another hook 122. Orienting hooks 122 in opposite directions allows the hooks 122 to better secure the body 120 to the filament mesh structure 90, such as during dynamic loading in which the seat occupant moves or bounces on the cushion 50. A similar hook arrangement is provided in the top left and right corners of FIG. 4 in which a pair of hooks 122, 122 that are disposed along the perimeter face away from a hook 122 that is disposed adjacent to an aperture 134 that is configured as a through hole and that is oriented at approximately a 45° angle with respect to a horizontal line that extends from left to right from the perspective shown. As such, the perimeter hooks 122, 122 generally extend away from the center of the body 120 while the hook 122 visible through the angled aperture 134 extends toward the center of the body 120. As such, a hook 122 that is disposed along or adjacent to the perimeter of the attachment pad 102 may face or extend in a different direction than the closest hook 122 that is not disposed along the perimeter to help the attachment pad 102 conform to the contour of the cushion 50 and hold the attachment pad 102 against the contour of the cushion 50 and help prevent the attachment pad 102 from detaching or disengaging from the filament mesh structure 90 of the cushion 50.

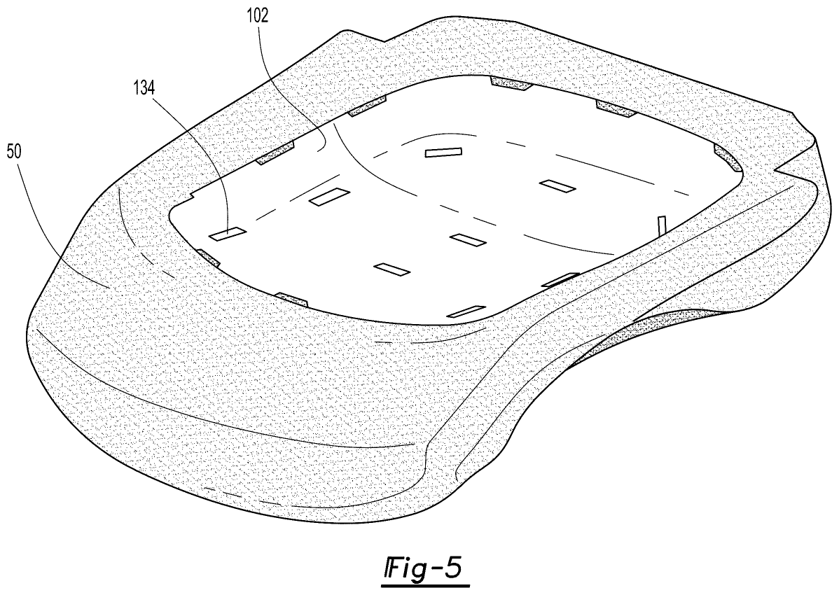

As is best shown in FIG. 5, the perimeter of the attachment pad 102 may be disposed at a higher elevation than the center region of the attachment pad 102. Thus, a perimeter hook 122 or hook that is located adjacent to the perimeter of the attachment pad 102 may be disposed at a higher elevation or further above a horizontal plane that is disposed under the cushion 50 than the hooks 122 that are not disposed along the perimeter of the attachment pad 102. Moreover, the attachment pad 102 may have a curved contour that extends downward from the perimeter to a hook 122 that is not disposed along the perimeter of the attachment pad 102.

As shown in FIG. 4, a hook 122 may be tapered or become narrower as the hook 122 extends away from the body 120 and toward an associated aperture 134, 134′. In some configurations, the hook 122 may be tapered and become narrower as the hook 122 extends toward a distal end or free end 160 of the hook 122.

Referring to FIG. 6, in some configurations, a hook 122 includes a first segment 150, a second segment 152, and a bend 154.

The first segment 150 extends from the body 120. For instance, the first segment 150 may extend from the first side 130 of the body 120. The first segment 150 may extend a direction that extends away from the trim cover 100. For example, the first segment 150 may extend from the first side 130 in a direction that extends away from the second side 132. In some configurations, the first segment 150 or a portion thereof may be disposed substantially perpendicular to an adjacent region of the second side 132.

The second segment 152 may extend from an end of the first segment 150. For instance, the second segment 152 may extend from an end of the first segment 150 that is disposed opposite the body 120. The second segment 152 extends in a different direction than the first segment 150. In some configurations, the first segment 150 and the second segment 152 meet at the bend 154 and are disposed in a nonparallel relationship. In some configurations, the second segment 152 extends at an acute angle al with respect to the first segment 150 such that the second segment 152 extends toward an adjacent aperture 134, 134′ in the body 120 or in an upward direction toward the second side 132.

The second segment 152 has a free end 160. The free end 160 is disposed at an end of the second segment 152 that is disposed opposite the first segment 150 and the bend 154 if provided. The free end 160 is configured to be positioned in the filament mesh structure 90 or may not extend past the contoured exterior side 110 when the attachment pad 102 is installed and coupled to the filament mesh structure 90. When installed, the free end 160 may be disposed below the second side 132 so that the free end 160 does not poke a seat occupant, create a bulge or distortion in the trim cover, or both. For instance, the free end 160 or a portion thereof may protrude into the aperture 134, 134′ as shown or may be disposed completely below the second side 132 and inside the filament mesh structure 90 so that the free end 160 does not poke a seat occupant.

The first segment 150 and the second segment 152 may cooperate to form the bend 154. The bend 154 may have an arcuate or curved profile when the hook 122 is in a nominal or default position as shown in FIG. 6. The hook 122 may be configured to flex or bend at the bend 154.

Referring to FIGS. 6-9, examples of steps associated with a method of assembly are illustrated. FIGS. 6-9 are section views taken through a hook 122 and adjacent aperture 134 of the attachment pad 102 and through the filament mesh structure 90 of the cushion 50. The filament mesh structure 90 is illustrated in a simplified form in which various filaments 52 disposed behind the section plane are omitted for clarity. In addition, some filaments 52 that intersect the section plane are illustrated as being cross sectioned and more specifically with cross-sectioned circles for simplicity. It is to be understood that a filament 52 may intersect the section plane in a non-perpendicular manner and thus that a sectioned filament 52 may more accurately be depicted in a noncircular manner, such as with an oval, ellipse, or other noncircular shape.

Installation of the attachment pad 102 on the filament mesh structure 90 will be described primarily in the context of attachment with a single hook 122; however it is to be understood that some or all of the hooks 122 of the attachment pad 102 may be installed in a similar manner and that hooks may be installed simultaneously or sequentially.

Referring to FIG. 6, the cushion 50 and attachment pad 102 are shown prior to assembly. The attachment pad 102 is aligned with a desired installation location on the cushion 50 with the first side 130 facing toward the exterior side 110 of the cushion 50 and hook 122 extending toward the exterior side 110 of the cushion 50. The bend 154 of the hook 122 may engage or contact the exterior side 110 while the remainder of the attachment pad 102 may be spaced apart from or disposed above the cushion 50.

Referring to FIG. 7, the attachment pad 102 is actuated toward the filament mesh structure 90 of the cushion 50. The attachment pad 102 may be actuated toward the filament mesh structure 90 by moving the body 120 of the attachment pad 102 toward the exterior side 110, by moving the cushion 50 and its exterior side 110 toward the attachment pad 102, or combinations thereof. In the example shown, the attachment pad 102 is depicted as being actuated against the cushion 50 such that the first side 130 of the body 120 engages or contacts the exterior side 110 of the cushion 50 in response to a downward force exerted against the second side 132 of the attachment pad 102 as represented by the vertical arrowed lines. Force may be exerted in any suitable manner. For instance, force may be exerted manually or with a machine or apparatus such as a press.

Force applied against the attachment pad 102 forces the hook 122 through the exterior side 110 and into the filament mesh structure 90. Filaments 52 of the filament mesh structure 90 that engage or contact the hook 122 may be moved or displaced by the hook 122 as the hook 122 is inserted into the filament mesh structure 90. Movement or displacement of filaments 52 may be limited by the bonds between filaments 52. As a result, the filaments 52 provide some resistance against insertion of the hook 122. In response, the hook 122 flexes. For instance, the first segment 150, the second segment 152, or both may bend or flex with respect to its initial configuration in FIG. 6. In FIG. 7, the hook 122 is illustrated as primarily being flexed at the bend 154 such that the second segment 152 flexes or bends upward with respect to the body 120 and extends toward, into, or through the aperture 134 in the body 120 that is disposed adjacent to the hook 122. As a result, the angle α2 between the first segment 150 and the second segment 152 may be less than the angle α1 prior to insertion. In the example shown, the hook 122 flexes such that the free end 160 is pushed upward into and through the aperture 134 such that the free end 160 protrudes out of the aperture 134 and is disposed above the second side 132 of the body 120. In some configurations, the free end 160 moves upward past the first side 130 of the body 120 into the aperture 134 without protruding above the second side 132. In other configurations, the free end 160 may move upward but may not enter the aperture 134.

The first segment 150 and the second segment 152 may act like a wedge that forces one or more filaments 52 around the hook 122. As a result, filaments 52 may be moved away from the gap 170 that is located between the first segment 150 and the second segment 152 that may be located above the bend 154, thereby resulting in no filaments 52 being disposed in the gap 170 or fewer filaments 52 being disposed in the gap 170 as compared to adjacent areas of the filament mesh structure 90.

Referring to FIG. 8, the hook 122 is actuated (e.g., pushed, pulled, moved, flexed, bent, positioned) with respect to the body 120 into the cushion 50. Actuation of the hook 122 may occur while the body 120 is held against the exterior side 110 of the cushion 50. Actuating the hook 122 flexes the hook away from the body 120 and toward the filament mesh structure 90. For example, actuating the hook 122 may include pushing a portion of the hook 122 into the filament mesh structure 90, pulling the hook into the filament mesh structure 90, or combinations thereof. Actuation of the hook 122 will primarily be discussed below in the context of pushing the hook 122 into the filament mesh structure 90.

In some configurations, force is exerted against the hook 122 with a tool 180, such as a shaft, rod, lever, bar, wedge, or the like. As an example, the tool 180 may be aligned with a portion of the hook 122, such as the second segment 152. Then, the tool 180 may be engaged with the second segment 152. For instance, the tool 180 may engage or contact the second segment 152 between the free end 160 and the bend 154. Depending on the positioning of the tool 180, the tool may enter or pass through the aperture 134 before or after the tool 180 engages the second segment 152. Force may be applied with the tool 180 to push the second segment 152 downward and into the filament mesh structure 90. Force may be applied with the tool 180 against the second segment 152 in a manner that causes the hook 122 to bend or flex away from the first segment 150. The hook 122 may bend or flex at the bend 154. Some or all of the force exerted with the tool 180 may be directed toward the filament mesh structure 90.

The application of sufficient force with the tool 180 pushes the second segment 152 deeper into the filament mesh structure 90. As a result, flexing or bending may occur along the first segment 150, the second segment 152, the bend 154, or combinations thereof. The second segment 152 may bend, flex, or otherwise move away from the body 120 and the second side 132 such that the free end 160 moves into the filament mesh structure 90 or is pushed deeper into the filament mesh structure 90 and further away from the exterior side 110. In some configurations, force may be applied such that the angle α3 between the first segment 150 and the second segment 152 increases and is greater than the angle α1 shown in FIG. 6. For instance, the angle α3 may be greater than 90°, such as between 90° and 180°. As a result, the second segment 152 may extend away from the body 120, thereby allowing one or more filaments 52 to enter the gap 170 between the first segment 150 and the second segment 152. In some configurations, the free end 160 is disposed below the first segment 150, the bend 154, or both or further away from the first side 130 than the first segment 150, the bend 154, or both when pushed into the filament mesh structure 90.

Referring to FIG. 9, the hook 122 is shown after being released. Releasing the hook 122 may allow the hook 122 to flex back toward or back to its initial position shown in FIG. 6. The hook 122 may be released by retracting the tool 180 and/or disengaging the tool 180 from the hook 122. Releasing the hook 122 allows the hook 122 to capture, snag, grasp, or otherwise catch hold of one or more members of the set of filaments 52, thereby coupling the attachment pad 102 to the filament mesh structure 90. In the configuration shown, releasing the hook 122 allows the second segment 152 to move upward toward the body 120 and the aperture 134 such that one or more filaments 52 are positioned in the gap 170 and are captured between the first segment 150 and the second segment 152 of the hook 122. Thus, at least one member of the set of filaments 52 may engage the hook 122 and be received between the first segment 150 and the second segment 152. After being released, the second segment 152 may extend toward or into the aperture 134 and toward the trim cover 100 when the trim cover 100 is installed.

A member of the set of filaments 52 may engage the first side 130 of the body 120 and the hook 122. For instance, filament 52′ is illustrated as engaging the first side 130 and at least one of the first segment 150 and the second segment 152 of the hook 122. An example of the resulting assembly with the attachment pad 102 coupled to the cushion 50 is shown in FIG. 5.

The trim cover 100 may be attached to the body 120 before or after the attachment pad 102 is secured or coupled to the filament mesh structure 90. In some configurations, the trim cover 100 is attached to the attachment pad 102 after the hooks 122 are released and the attachment pad 102 is coupled to the cushion 50. It is also contemplated that the trim cover 100 may be attached to the attachment pad 102 before the hooks 122 are inserted into the filament mesh structure 90, which may be implemented in a configuration in which the attachment pad 102 is pulled against the filament mesh structure 90.

Referring to FIG. 3, the trim cover 100 may be attached to the second side 132 of the body 120. The trim cover 100 may be attached to the body 120 in any suitable manner. For instance, the trim cover 100 may be attached the attachment pad 102 by adhering or bonding the trim cover 100 to the body 120, such as with an adhesive 190 that is disposed between the underside of the trim cover 100 and the second side 132. It is also contemplated that the trim cover 100 may be attached to the attachment pad 102 with a fastener, such as a hook and loop fastener.

The present invention may allow a cushion to be provided with an attachment pad that helps better secure a trim cover in locations that are positioned near the center of the cushion without providing recesses or trenches in the cushion in which a trim clip is disposed. The present invention may allow a trim cover to be secured with an attachment pad that may provide a larger surface area for attaching the trim cover as compared to using individual trim clips, which may provide a greater surface area along which the trim cover and the attachment pad may be attached, thereby securing the trim cover at more locations as compared to trim clips. The present invention may allow an attachment pad to be reliably secured to a filament mesh structure with multiple hooks that may be arranged in different directions so that multiple hooks are oriented to counteract load forces and inhibit detachment of the attachment pad. In addition, the attachment pad and filament mesh structure may be recyclable together, thereby avoiding disassembly during the recycling process.

Clause 1. A seat assembly comprising: a cushion that comprises a filament mesh structure, the filament mesh structure comprising a set of filaments of thermoplastic material, wherein each member of the set of filaments is looped and bonded to at least one other member of the set of filaments; an attachment pad comprising a body and a set of hooks that extend from the body and couple the attachment pad to the filament mesh structure, wherein the body is disposed on a contoured exterior side of the filament mesh structure; and a trim cover that is attached to the attachment pad.

Clause 2. The seat assembly of clause 1 wherein each member of the set of hooks extends from the body at a different location.

Clause 3. The seat assembly of any preceding clause wherein members of the set of hooks extend into the filament mesh structure and catch hold of at least one filament of the filament mesh structure.

Clause 4. The seat assembly of any preceding clause wherein each member of the set of hooks further comprises a first segment and a second segment, wherein the first segment extends from the body and away from the trim cover, and the second segment extends from an end of the first segment toward the trim cover.

Clause 5. The seat assembly of clause 4 wherein the second segment further comprises a free end that is disposed opposite the first segment, wherein the free end is positioned in the filament mesh structure.

Clause 6. The seat assembly of any preceding clause wherein the body further comprises a first side and a second side that is disposed opposite the first side, wherein the first side engages the contoured exterior side of the cushion and the second side engages the trim cover.

Clause 7. The seat assembly of clause 6 when dependent on clause 4 wherein the body defines an aperture that extends from the first side to the second side of the body, and the second segment extends from an end of the first segment toward the aperture.

Clause 8. The seat assembly of clause 4, clause 5, clause 6 when dependent on claim 4, or clause 7 wherein a member of the set of filaments engages a member of the set of hooks and is received between the first segment and the second segment.

Clause 9. The seat assembly of clause 6, clause 7, or clause 8 when dependent on clause 6 wherein a member of the set of filaments engages the first side of the body and at least one of the first segment and the second segment of a member of the set of hooks.

Clause 10. The seat assembly of any preceding clause wherein the set of hooks comprises a first hook and a second hook, wherein the body further comprises a first and second apertures that extend from a first side to a second side of the body, wherein the first hook is disposed adjacent to the first aperture and the second hook is disposed adjacent to the second aperture.

Clause 11. The seat assembly of clause 10 wherein the first hook and the second hook extend in opposite directions.

Clause 12. The seat assembly of clause 10 or clause 11 wherein the first aperture is a through hole that is encircled by the body and the second aperture is disposed along a perimeter of the body and is not encircled by the body.

Clause 13. A method comprising: engaging an attachment pad and a cushion, the attachment pad comprising a body and a hook that extends from the body, and the cushion comprising a filament mesh structure, the filament mesh structure comprising a set of filaments of thermoplastic material, wherein each member of the set of filaments is looped and bonded to at least one other member of the set of filaments; actuating the hook with respect to the body; and releasing the hook, thereby allowing the hook catch hold of at least one member of the set of filaments and couple the attachment pad to the filament mesh structure.

Clause 14. The method of clause 13 wherein actuating the hook flexes the hook away from the body, and releasing the hook allows the hook to flex toward the body.

Clause 15. The method of clause 13 or clause 14 wherein engaging the attachment pad and the cushion further comprises engaging a first side of the body with the filament mesh structure and actuating the hook occurs when the first side of the body engages the filament mesh structure.

Clause 16. The method of any of clauses 13 to 15 wherein actuating the hook further comprises pushing the hook into the filament mesh structure.

Clause 17. The method of any of clauses 13 to 16 wherein actuating the hook further comprises exerting force against the hook with a tool.

Clause 18. The method of clause 17 wherein releasing the hook further comprises disengaging the tool from the hook.

Clause 19. The method of any of clauses 13 to 18 further comprising attaching a trim cover to the attachment pad after releasing the hook.

Clause 20. The method of clause 19 wherein the attaching the trim cover to the attachment pad further comprises adhering the trim cover to the body with an adhesive.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a cushion, that comprises a filament mesh structure, the filament mesh structure comprising a set of filaments of thermoplastic material, wherein each member of the set of filaments is looped and bonded to at least one other member of the set of filaments;
an attachment pad comprising a body and a set of hooks that extend from the body and couple the attachment pad to the filament mesh structure, wherein the body is disposed on a contoured exterior side of the filament mesh structure; and
a trim cover that is attached to the attachment pad.

2. The seat assembly of claim 1 wherein each member of the set of hooks extends from the body at a different location.

3. The seat assembly of claim 1 wherein members of the set of hooks extend into the filament mesh structure and catch hold of at least one filament of the filament mesh structure.

4. The seat assembly of claim 1 wherein each member of the set of hooks further comprises a first segment and a second segment, wherein the first segment extends from the body and away from the trim cover, and the second segment extends from an end of the first segment toward the trim cover.

5. The seat assembly of claim 4 wherein the second segment further comprises a free end that is disposed opposite the first segment, wherein the free end is positioned in the filament mesh structure.

6. The seat assembly of claim 4 wherein the body further comprises a first side and a second side that is disposed opposite the first side, wherein the first side engages the contoured exterior side of the cushion and the second side engages the trim cover.

7. The seat assembly of claim 6 wherein the body defines an aperture that extends from the first side to the second side of the body, and the second segment extends from an end of the first segment toward the aperture.

8. The seat assembly of claim 7 wherein a member of the set of filaments engages a member of the set of hooks and is received between the first segment and the second segment.

9. The seat assembly of claim 7 wherein a member of the set of filaments engages the first side of the body and at least one of the first segment and the second segment of a member of the set of hooks.

10. The seat assembly of claim 1 wherein the set of hooks comprises a first hook and a second hook, wherein the body further comprises a first and second apertures that extend from a first side to a second side of the body, wherein the first hook is disposed adjacent to the first aperture and the second hook is disposed adjacent to the second aperture.

11. The seat assembly of claim 10 wherein the first hook and the second hook extend in opposite directions.

12. The seat assembly of claim 10 wherein the first aperture is a through hole that is encircled by the body and the second aperture is disposed along a perimeter of the body and is not encircled by the body.

13. A method comprising:
engaging an attachment pad and a cushion, the attachment pad comprising a body and a hook that extends from the body, and the cushion comprising a filament mesh structure, the filament mesh structure comprising a set of filaments of thermoplastic material, wherein each member of the set of filaments is looped and bonded to at least one other member of the set of filaments;
actuating the hook with respect to the body; and
releasing the hook, thereby allowing the hook catch hold of at least one member of the set of filaments and couple the attachment pad to the filament mesh structure.

14. The method of claim 13 wherein actuating the hook flexes at least a portion of the hook away from the body, and releasing the hook allows at least a portion of the hook to flex toward the body.

15. The method of claim 13 wherein engaging the attachment pad and the cushion further comprises engaging a first side of the body with the filament mesh structure and actuating the hook occurs when the first side of the body engages the filament mesh structure [hooks are actuated when the attachment pad is flush against the cushion so the attachment pad is tightly secured].

16. The method of claim 13 wherein actuating the hook further comprises pushing the hook into the filament mesh structure.

17. The method of claim 13 wherein actuating the hook further comprises exerting force against the hook with a tool.

18. The method of claim 17 wherein releasing the hook further comprises disengaging the tool from the hook.

19. The method of claim 13 further comprising attaching a trim cover to the attachment pad after releasing the hook.

20. The method of claim 19 wherein the attaching the trim cover to the attachment pad further comprises adhering the trim cover to the body with an adhesive.
